(19) United States
(12) Patent Application Publication
(10) Pub. No.: US 2011/0036206 A1
(43) Pub. Date: Feb. 17, 2011

(54) Sun gear-driven magnification driving tool

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/461,524

(22) Filed: Aug. 14, 2009

(51) Int. Cl. B25B 17/02

(52) U.S. Cl. 81/57

(57) ABSTRACT

The present invention of a sun gear-driven magnification driving tool relies on randomly attachable and removable sun gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

### BACKGROUND OF THE INVENTION

(a) Field of the Invention

The sun gear-driven screw and nut set installs the outer ring gear on the nut, and installs the planetary gear on the bolt. The screw and nut set must be installed in the planetary gear set structure one by one which entails a relatively high production cost. The present invention of a sun gear-driven magnification driving tool relies on randomly attachable and removable sun gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

(b) Description of the Prior Art

The sun gear-driven screw and nut set installs the outer ring gear on the nut, and installs the planetary gear on the bolt. The screw and nut set must be installed in the planetary gear set structure one by one. Each screw and nut set must all be installed on the gear set which entails a relatively high production cost.

### SUMMARY OF THE INVENTION

The present invention of a sun gear-driven magnification driving tool relies on randomly attachable and removable sun gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

### BRIEF DESCRIPTION OF THE DRAWINGS

FIG. 1 is a top cross-sectional view of the present invention

FIG. 2 is a cross sectional view of the present invention

FIG. 3 is a bottom view of the present invention

FIG. 4 is a dimensional exploded view of the present invention

FIG. 5 is a dimensional view of the polyhedral cylinder (141′) replacing the inner polygonal hole (141) in FIG. 5 of the present invention

FIG. 6 is a sectional view of the installation of polyhedral cylinder (141′) in FIG. 1 to FIG. 4 of the present invention

FIG. 7 is an operational dimensional view of the screw-on type guard of the present invention

FIG. 8 is the cross-sectional view of FIG. 7

FIG. 9 is a dimensional view of the inner polygonal hole (124) replacing the polyhedral cylinder (124′) in FIG. 1 to FIG. 4

FIG. 10 is the cross-sectional view of FIG. 9

FIG. 11 is an operational view of the installation of an axial hole (125′) on the sun gear cylinder (121) and the installation of an boss (126′) on the planetary gear radial arm base (127)

FIG. 12 is a functional view of the driven stud (140) being welded on the structure (200)

FIG. 13 is a functional view of the stud (140) being screwed on the screw hole of the structure (200) of the present invention

FIG. 14 is a functional view of the present invention showing the stud (140) penetrating the structure with the other end installed with a nut

FIG. 15 is a functional view of the stud (140) of the present invention penetrating through the structure (200) with a limit stud bolt head at the other end

FIG. 16 is a functional view of the present invention showing both ends of the stud (140) installed with nuts (101)

### DESCRIPTION OF MAIN COMPONENT SYMBOLS

(100): Cover
(101): Nut
(102): Inner ring gear
(103): Sleeve
(111): Nut-driven ring body
(115): Fixed screw
(112): Inner thread
(121): Sun gear cylinder
(122): Cylindrical tooth tip
(123): Polyhedral prismatic structure
(123′): Sleeve with inner polygonal hole
(124): Inner polygonal hole
(124′): Polyhedral cylinder
(125): Boss
(125′): Axial hole
(126): Axial hole
(126′): Boss
(127): Planetary gear radial arm base
(128): Jack post
(131): Planetary gear
(140): Stud
(141): Inner polygonal hole
(141′): Polyhedral cylinder
(142): Thread
(200): Structure
(300): Fixed element

### DETAILED DESCRIPTION OF THE PREFERRED EMBODIMENTS

The sun gear-driven screw and nut set installs the outer ring gear on the nut, and installs the planetary gear on the bolt. The screw and nut set must be installed in the planetary gear set structure one by one which entails a relatively high production cost. The present invention of a sun gear-driven magnification driving tool relies on randomly attachable and removable sun gear-driven magnification driving tools to lock, adjust, and disassemble applied mechanism with screw structure such as screw locking device, screw adjusting device, and individual screw and nut set that do not need the installation of outer ring gear and planetary gear while reducing the installation cost for over a pair of such mechanisms.

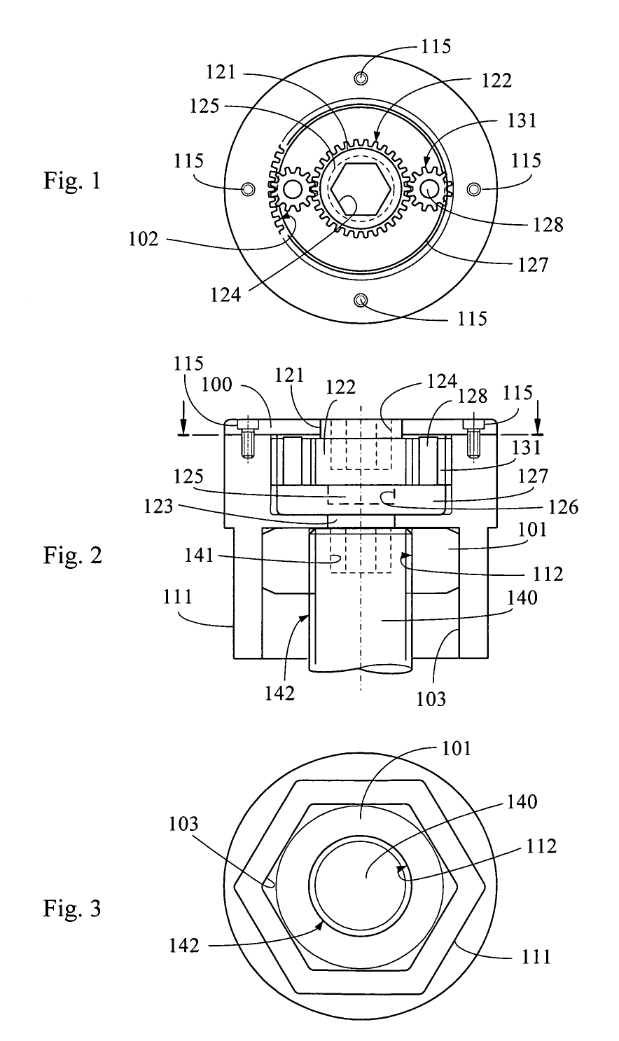

FIG. 1 is the top cross-sectional view of the present invention.

FIG. 2 is a cross-sectional of the present invention.

FIG. 3 is the bottom view of the present invention.

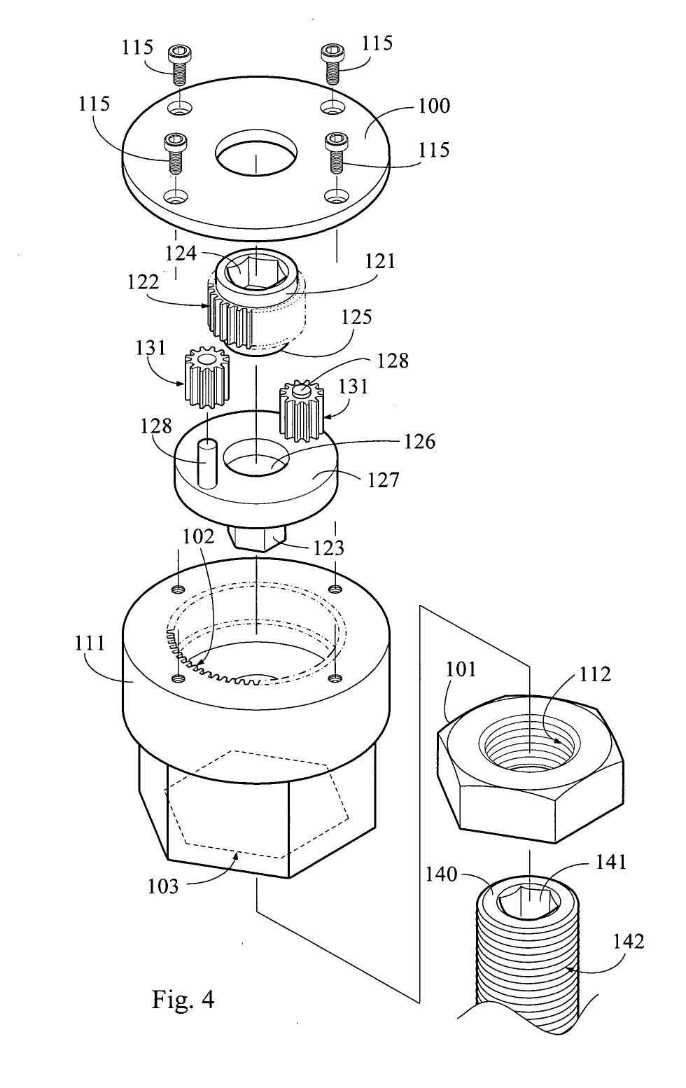

FIG. 4 is a dimensional exploded view of the present invention.

As shown in FIG. 1 to FIG. 4, the present invention drives the following screw and nut devices including:
Nut (101): A structure with polygonal exterior and inner thread (112) on inner part for fastening on the thread (142) of the stud (140);
Stud (140): Stud (140) includes threads (142) while the stud head of the stud (140) includes concave polygonal hole (141) or it assumes the form of a polyhedral cylinder (141′);

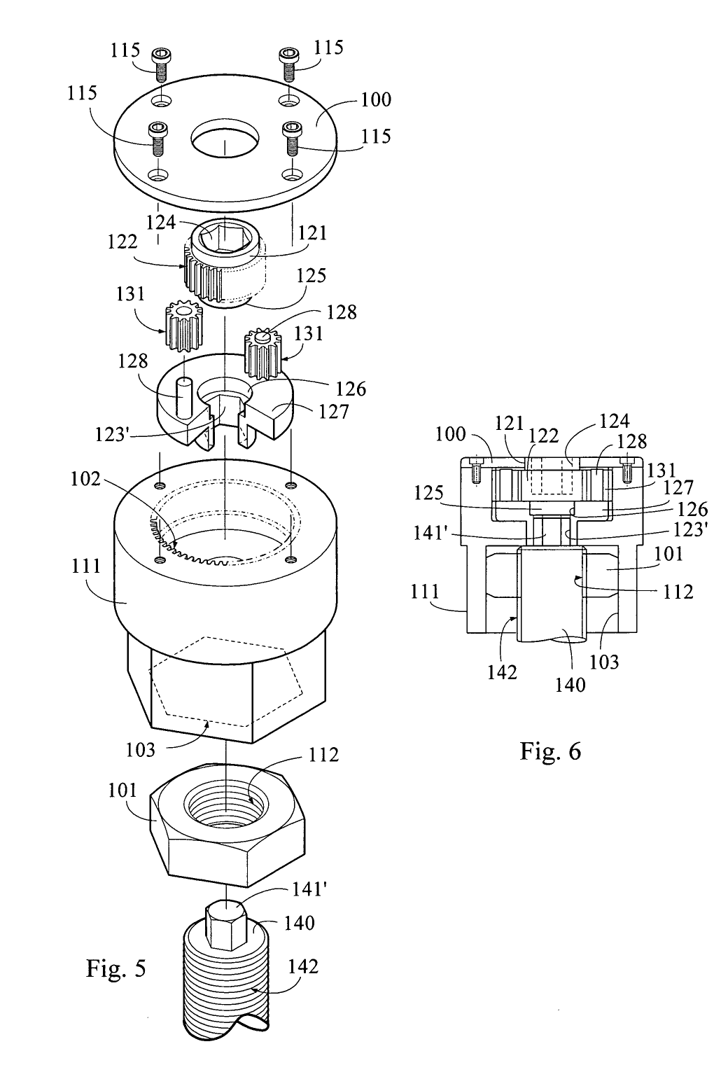

The inner polygonal hole (141) of the aforementioned stud head of the stud (140) is optionally replaced by the polyhedral cylinder (141′) as shown in the dimensional view in FIG. 5 wherein the polyhedral cylinder (141′) replaces the inner polygonal hole (141) in FIG. 1 to FIG. 4. When the polyhedral cylinder (141′) is chosen to be installed, the polyhedral prismatic structure (123) coupled with the polyhedral cylinder (141′) will be transformed into a sleeve with inner polygonal hole (123′) in order to fit into and drive the polyhedral cylinder (141′). FIG. 6 is a cross-sectional view of the installation of the polyhedral cylinder (141′) in FIG. 1 to FIG. 5.

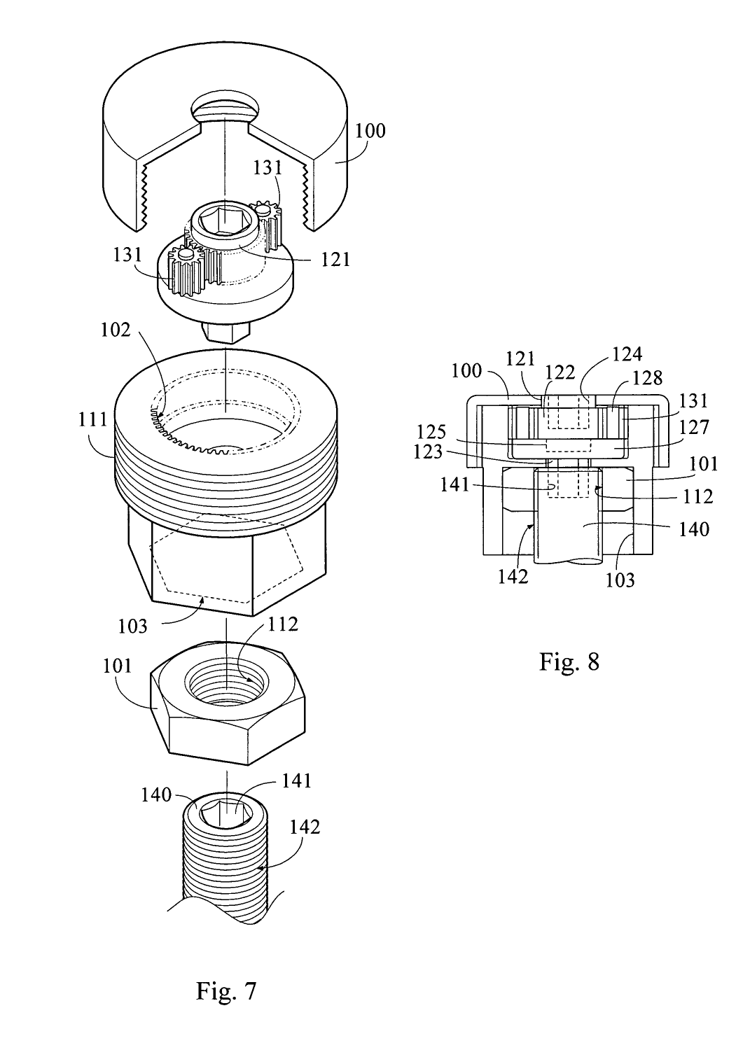

FIG. 7 is the operational dimensional view of the screw-on type guard of the present invention

FIG. 8 is the cross-sectional view of FIG. 7

The main components of the sun gear-driven magnification driving tool includes:
Cover (100): A removable cap-shape locking structure to provide fixed screw (115) a means of axial lockability or by using a bottle cap-shape cover as an outer ring to screw or fasten itself on the top section of the nut-driven ring body (111). The planetary gear set is protected by means of the aforementioned cover (100). The cover (100) has a hole in the middle for inserting a tool to drive the sun gear cylinder (121) or to provide an exposed opening at the upper axial section for tools to drive the sun gear cylinder (121).
Nut-driven ring body (111): A ring shape structure with its upper inner ring integrated as a whole or be installed with an inner ring gear (102) in an assembly manner. The lower section of the ring-shape structure includes a sleeve (103) to couple with the exterior side of the nut (101) so that when the inner ring gear (102) is driven, nut (101) is loosen or locked by its rotating or counter-rotating motion.
Planetary gear (131): To provide coupling between the sun gear of the sun gear cylinder (121) and the inner ring gear (102) of the installed nut-driven ring body (111) in order to form an interactive planetary gear set function.

The upper part of the planetary gear radial arm base (127) is installed with one or more jack posts (128) for the planetary gear (131) to effect rotary operation. Axial hole (126) is installed in planetary gear radial arm base (127) to allow the boss (125) at the lower end of the sun gear cylinder (121) to rotate in it. The lower side of the planetary gear radial arm base (127) is made into one piece or assembled to form a polyhedral prismatic structure (123) extending downwards in order to couple and move with the inner polygonal hole (141) on the top side of the stud (140) of the thread (142).
Sun gear cylinder (121): The sun gear cylinder is a cylindrical structure with its integrated top section or formed into cylindrical tooth tip (122) by assembly method. The top side of the cylindrical tooth tip (122) has inner polygonal hole (124) or the inner polygonal hole (124) is replaced with polyhedral cylinder (124′) in order to accept rotary drive by the operating tool. The lower end of the sun gear cylinder (121) has a boss (125) to couple with the axial hole (126) of the planetary gear radial arm base (127) for rotation. Sun gear cylinder (121) can accept drive from a separated and randomly coupling operational tool; or the operational tool can form an assembly with the sun gear cylinder (121) or be integrated as one structure.

The above-mentioned nut-driven ring body (111), sun gear cylinder (121), planetary gear (131) and the tools for driving the sun gear cylinder (121) collectively form the sun gear-driven magnification driving tool.

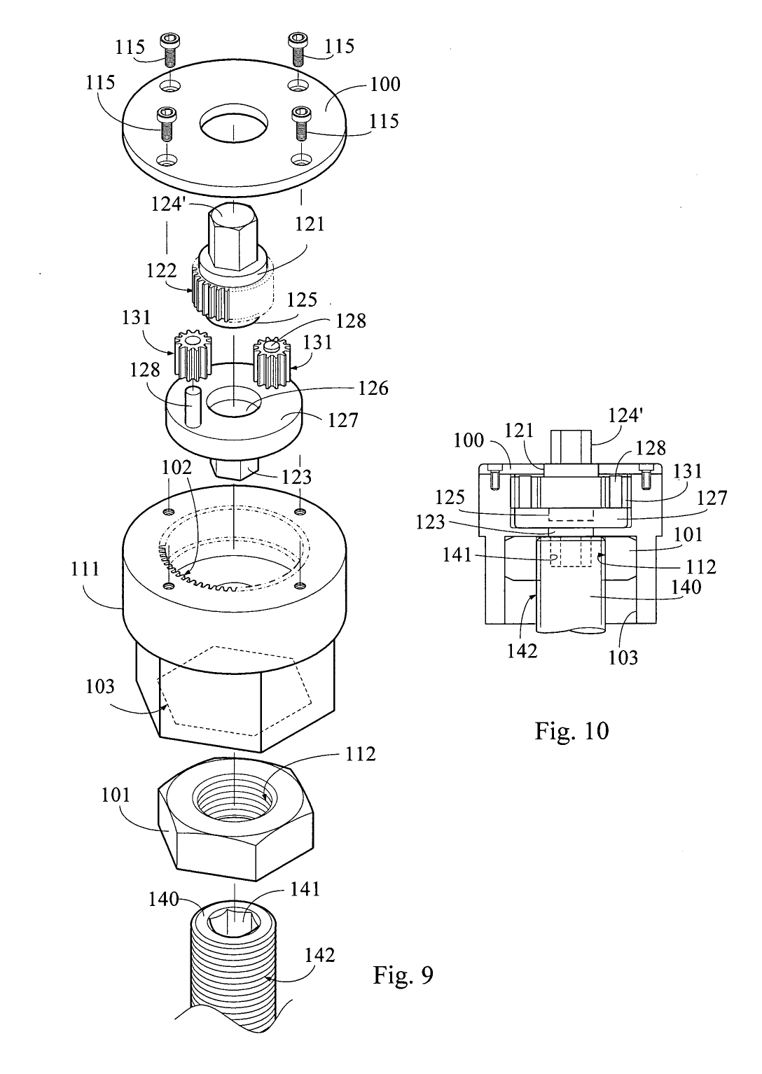

The sun gear-driven magnification driving tool, wherein the inner polygonal hole (124) of the sun gear cylinder (121) is optionally replaced by the polyhedral cylinder (124′) as shown in the dimensional view in FIG. 9 wherein the polyhedral cylinder (124′) replaces the inner polygonal hole (124) in FIG. 1 to FIG. 4. When the polyhedral cylinder (124′) is chosen to be installed, the formation will be as shown in the cross-sectional view of FIG. 10 regarding the installation of the polyhedral cylinder (124′) in FIG. 9.

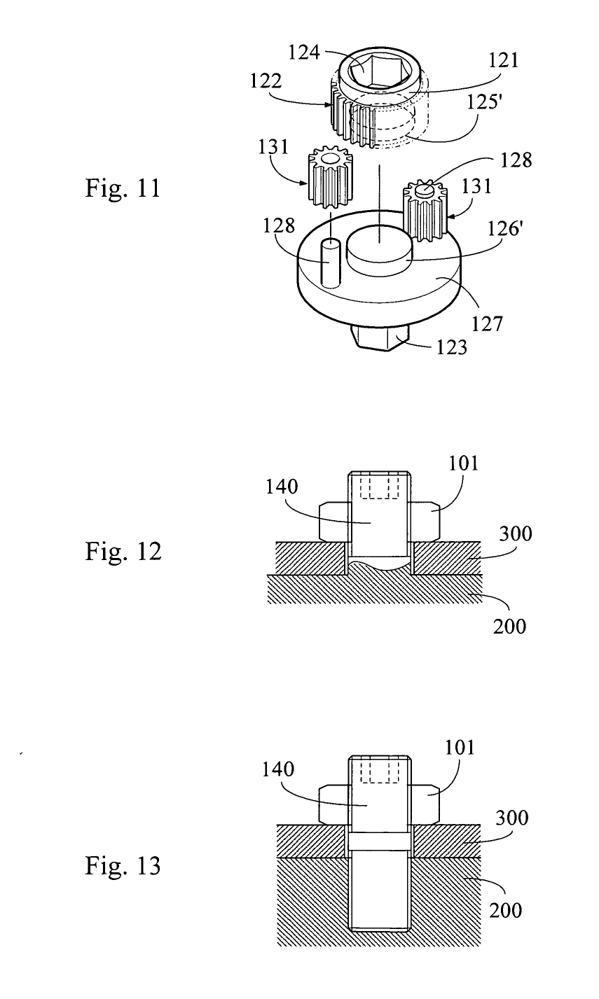

The aforementioned sun gear-driven magnification driving tool, wherein boss (125) that is installed on the sun gear cylinder (121) and the axial hole (126) that is installed in the planetary gear radial arm base (127) are also in the form of a reversed structure as shown in FIG. 11; an inter-rotating couple with one as the axial hole (125′), and the other as a boss (126′).

The aforementioned sun gear-driven magnification driving tool also makes or forms as an assembly the lower side of the aforementioned planetary gear radial arm base (127) into a sleeve with inner polygonal hole (123′) (as shown in FIG. 5) to replace the polyhedral prismatic structure (123) in order to couple and move with the relatively made polyhedral cylinder (141′) on top of the stud (140).

The aforementioned sun gear-driven magnification driving tool, wherein the operational tool is the optional screwdriver. The inner polygonal hole (141) of the stud (140) and/or the inner polygonal hole (124) of the sun gear cylinder (121) are converted into structures with slots to couple with the working end shape of the screw driver.

The present invention of a sun gear-driven magnification driving tool relies on manpower or fluid motor or mechanical power or electric motor to drive the operational tool for driving the sun gear cylinder (121); and to further drive the nut-driven ring body (111) with the inner ring gear (102). According to the speed reduction multiples of the planetary gear set, a magnification effect is produced to drive the nut (101) to screw on the thread (142) of the stud (140) in order to make locking or loosening drive.

Anti-vibration padding ring or gasket is optionally installed in the space between the drivable nut (101) and the stud (140) of the sun gear-driven magnification driving tool or the nut is directly screwed on the thread (142) of the stud (140). The bottom end of the stud (140) serves as:

1) The stud (140) is welded on the structure (200) and the nut (101) is screwed on the stud (140) to lock or release the fixed element (300). FIG. 12 is a functional view of the present invention showing the driven stud (140) being welded on the structure (200); or

2) The stud (140) is screwed into the screw hole of the structure (200) by means of the stud structure and the nut (101) is screwed on the stud (140) in order to lock or release the fixed element (300). FIG. 13 is a functional view of the present invention showing the stud (140) being screwed into the screw hole of the structure (200); or

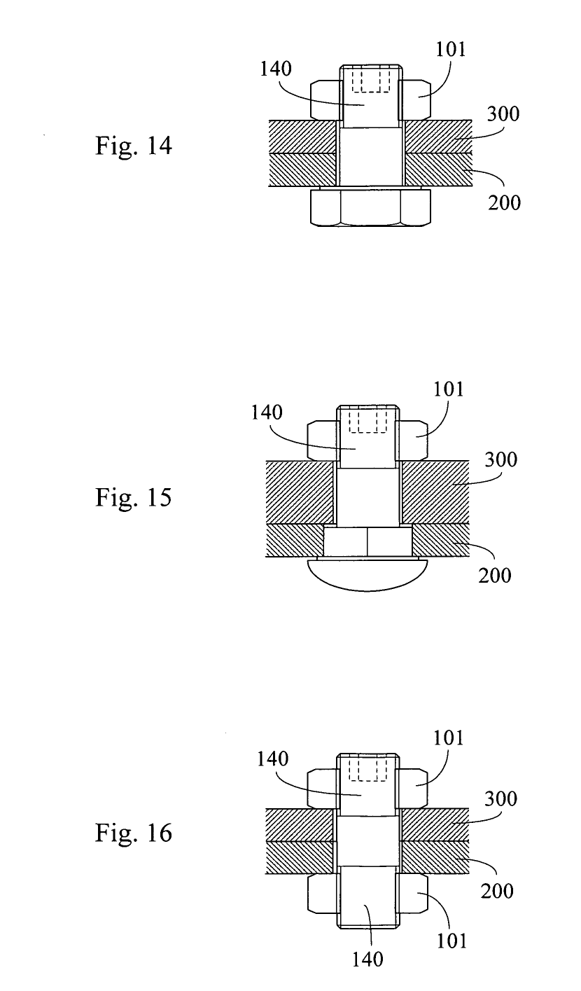

3) The stud (140) penetrates through the structure (200) with a nut at the other end joined to the structure (200); the nut (101) serves to screw onto the stud (140) in order to lock or release the fixed element (300); FIG. 14 is a functional view of the present invention showing the stud (140) penetrating the structure with the other end installed with a nut; or

4) The stud (140) penetrates through the structure (200) with a limit stud bolt head at the other end joined to the structure (200); the nut (101) serves to screw on the stud (140) in order to lock or release the fixed element (300). FIG. 15 is a functional view of the present invention showing the stud (140) penetrating through the structure (200) with a limit stud bolt head at the other end; or

5) The stud (140) penetrates through the structure (200) and the fixed element (300), and nuts (101) are screwed on both ends of the stud (140) in order to lock or release the fixed element (300). FIG. 16 is the functional view of the present invention showing both ends of the stud (140) installed with nuts (101);

Drive operational tool employs one or more driving method of operational drive on the sun gear cylinder (121) and/or stud (140) including: 1) one directional or reverse rotary drive 2) reciprocating type one-way drive in which one driving direction produces driving effect while the other does not produce driving effect; 3) reciprocating type one-way drive in which one driving direction is chosen to produce driving effect while the other direction does not produce driving effect.

Aside from the sun gear cylinder (121) having protruding polyhedral cylinder (124′) or inner polygonal hole (124); and/or the stud (140) head having inner protruding hole (141) or protruding polyheadral cylinder (141′), the kinds of sun gear-driven magnification driving tools are many. The following are merely some of the several modes which are not to be used as restrictions. Coupling modes are formed by one or more of the following:

1) The sun gear cylinder (121) can randomly couple with driving tools with T-type or L-type handles;

2) The sun gear cylinder (121) and the T-type or L-type handle driving tool assume an integrated structure or an assembled structure;

3) The randomly coupling driving tools of the sun gear cylinder (121), or the assembly type or integrated type driving tools including the T-type or L-type handles possess articulating structure with foldable or universal adjusting angles;

4) The sun gear cylinder (121) has concave inner polygonal hole (124) to accept drive modes of relatively coupleable driving tools including pulling by pulling tools or drive from rotary drive tools;

5) The sun gear cylinder (121) has protruding polyhedrons to accept driving modes of relatively coupling driving tools including drive by pulling tools or drive from rotary driving tools.

Aside from using various kinds of driving tools such as socket wrench, open wrench, closed wrench or polygonal wrench, the driving tool provided by the sun gear-driven magnification driving tools for driving the sun gear cylinder (121) and/or the stud (140) further include one or more of the following functional devices such as; 1) functional devices with torque limit; 2) functional devices which can adjust and set the required torque limit; 3) functional device with drive torque analog or digital display; 4) functional device that display drive torque with sound or voice; 5) functional device that displays drive torque with lamps.

1. A sun gear-driven magnification driving tool relies on randomly attachable and removable sun gear-driven magnification driving tools to lock, adjust, and disassemble applied mechanism with screw structure such as screw locking device, screw adjusting device, and individual screw and nut set that do not need the installation of outer ring gear and planetary gear;
the main components of the sun gear-driven magnification driving tool includes:
Cover (100): A removable cap-shape locking structure to provide fixed screw (115) a means of axial lockability or by using a bottle cap-shape cover as an outer ring to screw or fasten itself on the top section of the nut-driven ring body (111); the planetary gear set is protected by means of the aforementioned cover (100); the cover (100) has a hole in the middle for inserting a tool to drive the sun gear cylinder (121) or to provide an exposed opening at the upper axial section for tools to drive the sun gear cylinder (121);
Nut-driven ring body (111): A ring shape structure with its upper inner ring integrated as a whole or be installed with an inner ring gear (102) in an assembly manner; the lower section of the ring-shape structure includes a sleeve (103) to couple with the exterior side of the nut (101) so that when the inner ring gear (102) is driven, nut (101) is loosen or locked by its rotating or counter-rotating motion;
Planetary gear (131): To provide coupling between the sun gear of the sun gear cylinder (121) and the inner ring gear (102) of the installed nut-driven ring body (111) in order to form an interactive planetary gear set function;
the upper part of the planetary gear radial arm base (127) is installed with one or more jack posts (128) for the planetary gear (131) to effect rotary operation; axial hole (126) is installed in planetary gear radial arm base (127) to allow the boss (125) at the lower end of the sun gear cylinder (121) to rotate in it; the lower side of the planetary gear radial arm base (127) is made into one piece or assembled to form a polyhedral prismatic structure (123) extending downwards in order to couple and move with the inner polygonal hole (141) on the top side of the stud (140) of the thread (142);
the aforementioned installation is comprised of one or more jack post (128) and planetary gear (131);
Sun gear cylinder (121): The sun gear cylinder is a cylindrical structure with its integrated top section or formed into cylindrical tooth tip (122) by assembly method; the top side of the cylindrical tooth tip (122) has inner polygonal hole (124) or the inner polygonal hole (124) is replaced with polyhedral cylinder (124′) in order to accept rotary drive by the operating tool; the lower end of the sun gear cylinder (121) has a boss (125) to couple with the axial hole (126) of the planetary gear radial arm base (127) for rotation. Sun gear cylinder (121) can accept drive from a separated and randomly coupling operational tool;
the above-mentioned nut-driven ring body (111), sun gear cylinder (121), planetary gear (131) and the tools for driving the sun gear cylinder (121) collectively form the sun gear-driven magnification driving tool.

2. A sun gear-driven magnification driving tool as claimed in claim 1, wherein the operational tool can form an assembly with the sun gear cylinder (121) or be integrated as one structure.

3. A sun gear-driven magnification driving tool as claimed in claim 1, wherein the inner polygonal hole (124) of the sun gear cylinder (121) is optionally replaced by the polyhedral cylinder (124′).

4. A sun gear-driven magnification driving tool as claimed in claim 1, wherein the boss (125) that is installed on the sun gear cylinder (121) and the axial hole (126) that is installed in the planetary gear radial arm base (127) are also in the form of a reversed structure as such is to conduct an inter-rotating couple with one as the axial hole (125′), and the other as a boss (126′).

5. A sun gear-driven magnification driving tool as claimed in claim 1 also makes or forms as an assembly the lower side of the aforementioned planetary gear radial arm base (127) into a sleeve with inner polygonal hole (123′) to replace the polyhedral prismatic structure (123) in order to couple and move with the relatively made polyhedral cylinder (141′) on top of the stud (140).

6. A sun gear-driven magnification driving tool as claimed in claim 1, wherein the operational tool is the optional screwdriver; the inner polygonal hole (141) of the stud (140) and/or the inner polygonal hole (124) of the sun gear cylinder (121) are converted into structures with slots to couple with the working end shape of the screw driver.

7. A sun gear-driven magnification driving tool as claimed in claim 1 relies on manpower or fluid motor or mechanical power or electric motor to drive the operational tool for driving the sun gear cylinder (121); and to further drive the nut-driven ring body (111) with the inner ring gear (102); according to the speed reduction multiples of the planetary gear set, a magnification effect is produced to drive the nut (101) to screw on the thread (142) of the stud (140) in order to make locking or loosening drive.

8. A stud structure driven by the sun gear-driven magnification driving tool as claimed in claim 1, wherein the bottom end of the stud (140) is welded on the structure (200) and the nut (101) is screwed on the stud (140) to lock or release the fixed element (300), its characteristics is that the stud is facing towards the rear end of the tool, and it contains an inner polygonal hole or polyhedral.

9. A stud structure driven by the sun gear-driven magnification driving tool as claimed in claim 1, wherein the bottom end of the stud (140) is screwed into the screw hole of the structure (200) by means of the stud structure and the nut (101) is screwed on the stud (140) in order to lock or release the fixed element (300), its characteristics is that the stud is facing towards the rear end of the tool, and it contains an inner polygonal hole or polyhedral.

10. A stud structure driven by the sun gear-driven magnification driving tool as claimed in claim 1, wherein the bottom end of the stud (140) penetrates through the structure (200) with a nut at the other end joined to the structure (200); the nut (101) serves to screw onto the stud (140) in order to lock or release the fixed element (300), its characteristics is that the stud is facing towards the rear end of the tool, and it contains an inner polygonal hole or polyhedral.

11. A stud structure driven by the sun gear-driven magnification driving tool as claimed in claim 1, wherein the bottom end of the stud (140) penetrates through the structure (200) with a limit stud bolt head at the other end joined to the structure (200); the nut (101) serves to screw on the stud (140) in order to lock or release the fixed element (300), its characteristics is that the stud is facing towards the rear end of the tool, and it contains an inner polygonal hole or polyhedral.

12. A stud structure driven by the sun gear-driven magnification driving tool as claimed in claim 1, wherein the bottom end of the stud (140) penetrates through the structure (200) and the fixed element (300), and nuts (101) are screwed on both ends of the stud (140) in order to lock or release the fixed element (300), its characteristics is that the stud is facing towards the rear end of the tool, and it contains an inner polygonal hole or polyhedral.

13. A sun gear-driven magnification driving tool as claimed in claim 1 can drive the following screw and nut devices including:
Nut (101): A structure with polygonal exterior and inner thread (112) on inner part for fastening on the thread (142) of the stud (140);
Stud (140): Stud (140) includes threads (142) while the stud head of the stud (140) includes concave polygonal hole (141) or it assumes the form of a polyhedral cylinder (141′).

14. A sun gear-driven magnification driving tool as claimed in claim 13, wherein the inner polygonal hole (141) on the stud (140) is optionally replaced by the polyhedral cylinder (141′); when the polyhedral cylinder (141′) is chosen to be installed, the polyhedral prismatic structure (123) coupled with the polyhedral cylinder (141′) will be transformed into a sleeve with inner polygonal hole (123′) in order to fit into and drive the polyhedral cylinder (141′).
